(19) United States
(12) Patent Application Publication
(10) Pub. No.: US 2016/0234205 A1
(43) Pub. Date: Aug. 11, 2016

(54) METHOD FOR PROVIDING SECURITY SERVICE FOR WIRELESS DEVICE AND APPARATUS THEREOF

(71) Applicant: ELECTRONICS AND TELECOMMUNICATIONS RESEARCH INSTITUTE, Daejeon (KR)

(72) Inventors: Gae-Il AN, Daejeon (KR); Hyeok-Chan KWON, Daejeon (KR); Sin-Hyo KIM, Daejeon (KR); Jong-Sik MOON, Daejeon (KR); Sok-Joon LEE, Sejong (KR); Do-Young CHUNG, Daejeon (KR); Byung-Ho CHUNG, Daejeon (KR)

(21) Appl. No.: 15/007,073

(22) Filed: Jan. 26, 2016

(30) Foreign Application Priority Data
Feb. 11, 2015 (KR) 10-2015-0021174

(51) Int. Cl. H04L 29/06; H04W 12/06; H04W 12/08

(52) U.S. Cl. CPC H04L 63/0861; H04W 12/08; H04W 12/06

(57) ABSTRACT

Disclosed are a method for providing a security service for a wireless device and an apparatus thereof. The method includes obtaining a wireless fingerprint of a wireless device, determining a wireless device type corresponding to the obtained wireless fingerprint by referring to a first database, determining a security policy corresponding to the determined wireless device type by referring to a second database, and applying the determined security policy to a service for the wireless device, so that the wireless device is provided with a tight security service.

### CROSS-REFERENCE TO RELATED APPLICATION

This application claims priority to and the benefit of Korean Patent Application No. 10-2015-0021174, filed on Feb. 11, 2015, the disclosure of which is incorporated herein by reference in its entirety.

### BACKGROUND

1. Field of the Invention

The present disclosure relates to a method for providing a security service for a wireless device and an apparatus thereof

2. Discussion of Related Art

A wireless local area network (WLAN) provides a data communication between wireless devices, such as smartphones, Access Points (AP), and notebook computers that are equipped with a wireless LAN card. Unlike a wired local area network, the WLAN is exposed to the outside and thus more vulnerable in the security.

A wireless security system, such as a security AP and a Wireless Intrusion Prevention System (WIPS), performs a security management on a WLAN. In order for the wireless security system to perform a security management, information about the types of wireless devices is needed.

The wireless devices, as shown in FIG. 1, may be divided into various types according to a preset criterion (for example, an operating system, a manufacturer or a species). The type information of a wireless device may be used for various purposes.

For example, when a security manager desires to physically track an attacking wireless device, a wireless security system may provide the security manager with the species information about the wireless device (for example, information identifying whether the wireless device is a notebook computer or a smartphone) in addition to position information about the wireless device, thereby enhancing the effect of responding to the attack.

In addition, when performing an authentication on a wireless device, a security AP may use not only basic authentication information, such as a password, but also the degree of security vulnerability that is inferred based on the type information about the wireless device (for example, the species of OS installed on the wireless device), thereby increasing the security strength of WLAN.

In addition to the above examples, type information about a wireless device may be used in various applications, for example, statistical analysis on the use of wireless devices according to types, collecting position information about wireless devices of a certain type, and a wireless device type-based traffic filtering.

The conventional technology for obtaining type information about a wireless device is achieved by using an Organizationally Unique Identifier (OUI) method. OUI, which represents first 24 bits in a Media Access Control (MAC) address having 48 bits, is used as an identifier code of a manufacturer and is assigned by Institute of Electrical and Electronics Engineers (IEEE). However, the OUI method has a weak point that only limited information is obtained by analyzing the MAC address (for example, information about a manufacturer of a wireless device).

### SUMMARY

The present disclosure is directed to a method for effectively obtaining type information about a wireless device that is needed to provide the wireless device with a tight security service.

The present disclosure is directed to a method for obtaining type information about a wireless device based on a wireless fingerprint of the wireless device.

The present disclosure is directed to providing a security service based on type information about a wireless device.

In accordance with one aspect of the present disclosure, there is provided a method for providing a security service for a wireless device, the method including: obtaining a wireless fingerprint of a wireless device; determining a wireless device type corresponding to the obtained wireless fingerprint by referring to a first database; determining a security policy corresponding to the determined wireless device type by referring to a second database; and applying the determined security policy to a service for the wireless device.

The wireless fingerprint may include at least one of an Operating System (OS) fingerprint, a device driver fingerprint, a clock fingerprint, a Radio Frequency (RF) fingerprint, and an Organizationally Unique Identifier (OUI) fingerprint.

The obtaining of the wireless fingerprint may include obtaining the wireless fingerprint by analyzing at least one of wireless electromagnetic waves and a Media Access Control (MAC) frame of the wireless device.

The wireless device type may be divided based on at least one of an operating system, a manufacturer and a device species.

The second database may store a security policy related to at least one of a notification, an access control, and an authentication for each wireless device type.

The first database may store mapping information in which respective wireless device types are mapped to wireless fingerprints corresponding thereto.

The method may further include building the first database based on a plurality of pieces of wireless data collected from a plurality of wireless devices.

The building of the first database may include: collecting a plurality of pieces of wireless data from a plurality of wireless devices belonging to a same wireless device type; generating N wireless fingerprints based on N types of wireless data among the collected plurality of pieces of wireless data; selecting at least one of the generated N wireless fingerprints according to a preset criterion; and registering the selected wireless fingerprint as a fingerprint corresponding to a concerned wireless device type.

The selecting of the at least one of the N wireless fingerprints may include: measuring identification error rates of the generated N wireless fingerprints; and selecting a wireless fingerprint an identification error rate of which is measured to be the lowest.

The selecting of the at least one of the N wireless fingerprints may include: measuring identification error rates of the generated N wireless fingerprints; and selecting wireless fingerprints an identification error rate of which is measured to be smaller than a preset threshold value.

In accordance with another aspect of the present disclosure, there is provided an apparatus for providing a security service for a wireless device, the apparatus including a wireless device type determiner and a security service provider. The wireless device type determiner may be configured to obtain a wireless fingerprint of a wireless device, and determine a wireless device type corresponding to the obtained wireless fingerprint by referring to a first database. The security service provider may be configured to determine a security policy corresponding to the determined wireless device type by referring to a second database, and apply the determined security policy to a service for the wireless device.

The wireless device type determiner may obtain the wireless fingerprint by analyzing at least one of wireless electromagnetic waves and a Media Access Control (MAC) frame of the wireless device.

The apparatus may further include a wireless fingerprint mapping information register configured to build the first database based on wireless data collected from a plurality of wireless devices. The wireless fingerprint mapping information register may be configured to collect a plurality of pieces of wireless data from a plurality of wireless devices belonging to a same wireless device type, generate N wireless fingerprints based on N types of wireless data among the collected plurality of pieces of wireless data, select at least one of the generated N wireless fingerprints according to a preset criterion, and register the selected wireless fingerprint as a fingerprint corresponding to a concerned wireless device type.

The wireless fingerprint mapping information register may be configured to measure identification error rates of the generated N wireless fingerprints, select a wireless fingerprint an identification error rate of which is measured to be the lowest, and register the selected wireless fingerprint as a fingerprint corresponding to the concerned wireless device type.

The wireless fingerprint mapping information register may be configured to measure identification error rates of the generated N wireless fingerprints, select wireless fingerprints an identification error rate of which is measured to be smaller than a preset threshold value, and register the selected wireless fingerprint as a fingerprint corresponding to the concerned wireless device type.

As is apparent from the above, a wireless device can be provided with a tight security service.

A secure authentication, a security authenticating a strong tracking and an effective traffic filtering can be performed on a wireless device.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram illustrating the type of a wireless device;

FIG. 2 is a flowchart showing a method for providing a security service based on the type of a wireless device according to an exemplary embodiment of the present disclosure;

FIG. 3 is a drawing illustrating a first database according to an exemplary embodiment of the present disclosure;

FIG. 4 is a drawing illustrating a second database according to an exemplary embodiment of the present disclosure;

FIG. 5 is a flowchart showing a method for building a first database according to an exemplary embodiment of the present disclosure;

FIG. 6 is a block diagram illustrating an apparatus for providing a security service according to an exemplary embodiment of the present disclosure; and

FIG. 7 and FIG. 8 are diagrams illustrating an example in which an apparatus for providing a security service according to an exemplary embodiment of the present disclosure is applied to a distributed environment.

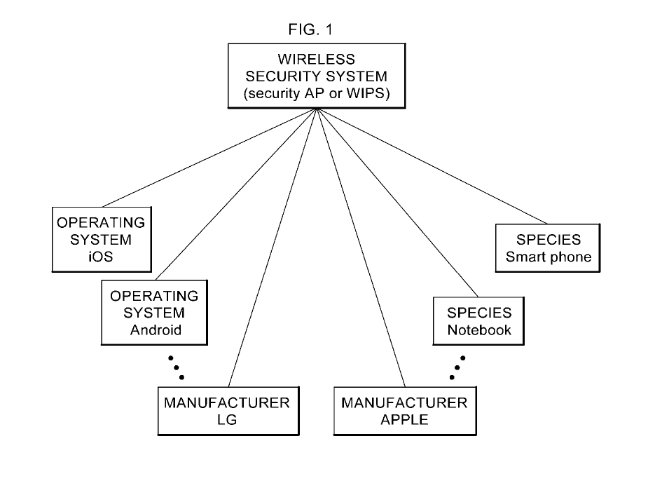

### DETAILED DESCRIPTION OF EXEMPLARY EMBODIMENTS

In describing the present disclosure, detailed descriptions that are well-known but are likely to obscure the subject matter of the present disclosure will be omitted in order to avoid redundancy.

Hereinafter, the exemplary embodiments of the present disclosure will be described with reference to the accompanying drawings.

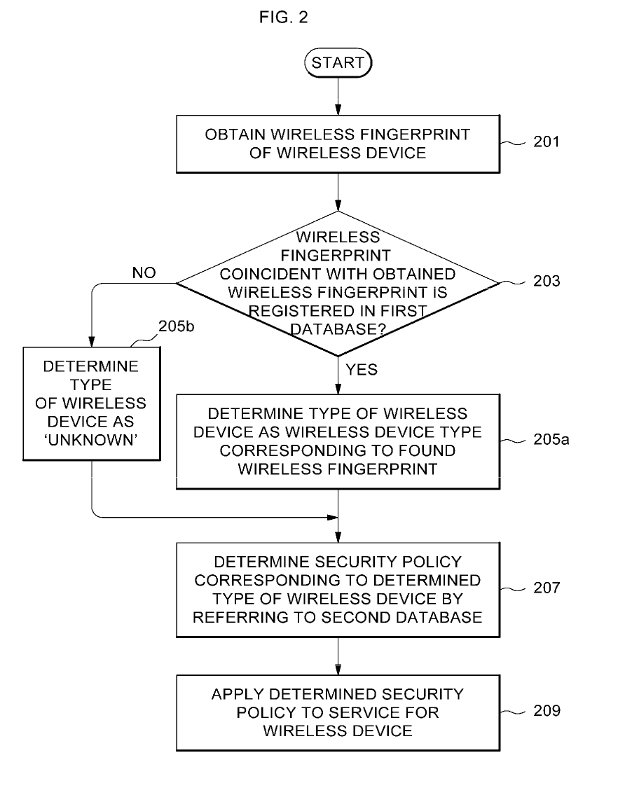

FIG. 2 is a flowchart showing a method for providing a security service based on the type of a wireless device according to an exemplary embodiment of the present disclosure.

A security service providing apparatus obtains a wireless fingerprint of a wireless device (hereinafter, referred to as a communication target wireless device) that performs a communication with the security service providing apparatus (S201). The wireless fingerprint may be obtained by analyzing wireless electromagnetic waves and a Media Access Control (MAC) frame received from the communication target wireless device.

According to an exemplary embodiment of the present disclosure, the wireless fingerprint represents information that allows the type of a wireless device to be identified. For example, the wireless fingerprint may be at least one of an Operating System (OS) fingerprint, a device driver fingerprint, a clock fingerprint, a Radio Frequency (RF) fingerprint, and an Organizationally Unique Identifier (OUI) fingerprint.

The OS fingerprint may be obtained through analysis of a communication protocol, and may indicate an OS used by the wireless device.

The device driver fingerprint may be obtained through analysis of a time difference between wireless service requests, such as ‘probe request’, and may indicate a device drive used by the wireless device.

The clock fingerprint is a fingerprint enabling a wireless device to be distinguished through analysis of an oscillator's clock skew that slightly varies at each device.

The RF fingerprint is a fingerprint enabling a wireless device to be distinguished through analysis of RF information, such as modulation error and signal transmission transient information (for example, transient shape) that are generated due to a subtle difference among hardware components of wireless devices. The modulation error represents information generated when a digital signal is modulated into an analogue in a wireless device transmitting data. As information for measuring the modulation error, an Error Vector Magnitude, a Frame Frequency Error, I/Q origin offset and Sync correlation may be used. The transient shape represents signal transient information between a point in time when a packet starts to be transmitted and a point in time when a signal corresponding to the packet is output.

The security service providing apparatus searches a first database whether a wireless fingerprint coincident with the obtained wireless fingerprint is registered in the first database (S203).

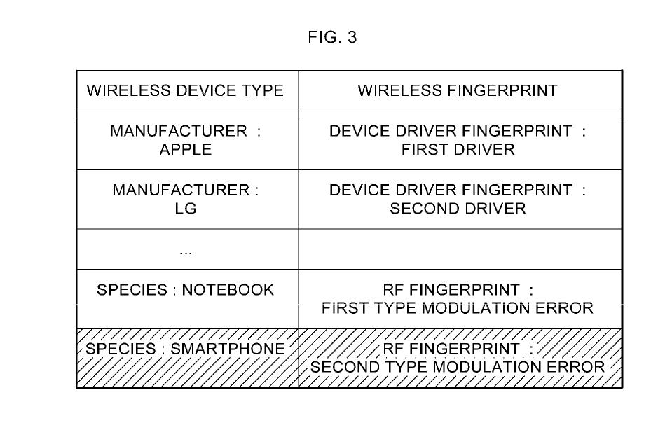

The first database stores mapping information in which respective wireless device types are mapped to wireless fingerprints corresponding thereto. An example of the first database will be described with reference to FIG. 3.

FIG. 3 is a drawing illustrating a first database according to an exemplary embodiment of the present disclosure.

Referring to FIG. 3, with respect to a plurality of wireless device types, wireless fingerprints corresponding to wireless device types, respectively, are registered.

For example, as for a wireless device having a manufacturer ‘APPLE’, a first driver is registered as a device driver fingerprint, and as for a wireless device having a manufacturer ‘LG’, a second driver is registered as a device driver fingerprint.

In addition, as for a wireless device having a device species ‘notebook’, a first type modulation error is registered as an RF fingerprint, and as for a wireless device having a device species ‘smartphone’, a second type modulation error is registered as an RF fingerprint.

Although FIG. 3 illustrates the wireless device types as being divided based on the manufacturer and the species of the device, the species of an operating system installed on the device and other various criteria may be used to divide wireless device types.

Although FIG. 3 illustrates a single wireless fingerprint as being registered for a single wireless device type, a plurality of wireless fingerprints may be registered for a single wireless device type.

Referring again to FIG. 2, if it is determined as a result of the search that a wireless fingerprint coincident with the wireless fingerprint of the communication target wireless device is registered in the first database, the security service providing apparatus proceeds to operation 205a and determines the type of the communication target wireless device as a wireless device type corresponding to the found wireless fingerprint (S205a).

For example, when the first database is built as shown in FIG. 3 and a wireless fingerprint of a communication target wireless device represents as a second type modulation error, the security service providing apparatus determines the type of the communication target wireless device as ‘smartphone’.

If it is determined as a result of the search that a wireless fingerprint coincident with the wireless fingerprint of the communication target wireless device is not registered in the first database, the security service providing apparatus proceeds to operation 205b and determines the type of the communication target wireless device as ‘Unknown’ (S205b).

The security service providing apparatus determines a security policy corresponding to the wireless device type determined in operation 205a or 205b by referring to a second database (S207).

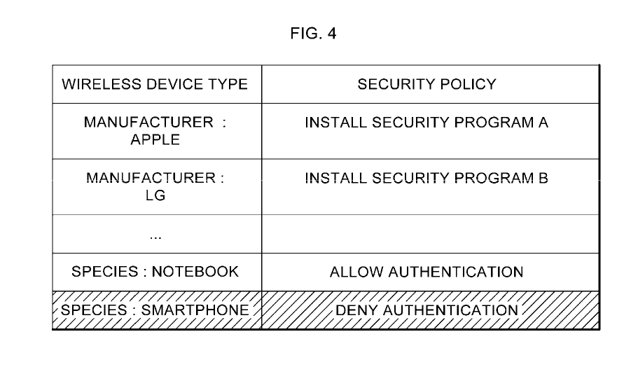

The second database stores a security policy related to at least one of a notification, an access control and an authentication for each wireless device type. An example of the second database will be described with reference to FIG. 4.

FIG. 4 is a drawing illustrating a second database according to an exemplary embodiment of the present disclosure.

Referring to FIG. 4, with respect to a plurality of wireless device types, security policies corresponding to wireless device types, respectively, are registered.

For example, for an access control of a wireless device having a manufacturer ‘APPLE’, a security policy that requires installation of a security program A is registered, and for an access control of a wireless device having a manufacturer ‘LG’, a security policy that requires installation of a security program B is registered.

In addition, for a wireless device having a device species ‘notebook’, a security policy allowing an authentication is registered, and for a wireless device having a device species ‘smartphone’, a security policy denying an authentication is registered.

In addition, the second database may register a security policy that sends a notification to an administrator when a certain type of communication target wireless device is found.

In addition, for a communication target wireless device having a wireless device type “unknown”, a security policy denying authentication for the communication target wireless device and blocking access of the communication target wireless device may be registered.

Although FIG. 4 illustrates a single security policy as being registered for a single wireless device type, a plurality of wireless security policies may be registered for a single wireless device type.

The security policy may be set by an administrator, or previously built and used.

Referring again to FIG. 2, the security service providing apparatus applies the determined security policy to a service for the communication target wireless device (S209).

For example, when the type of the communication target wireless device is determined as ‘smartphone’, the security service providing apparatus may deny authentication for the communication target wireless device since a security policy for smartphone' is registered as ‘deny authentication’.

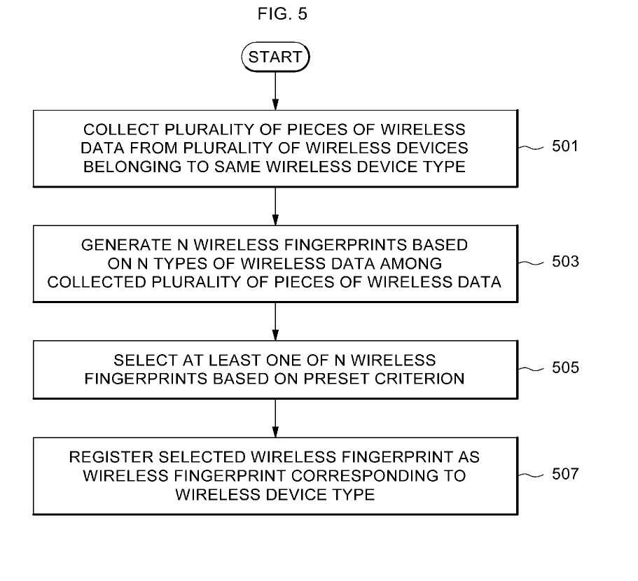

The process of providing a security service according to an exemplary embodiment of the present disclosure has been described with reference to the accompanying drawings. Hereinafter, a method for building the first database for providing a security service will be described with reference to FIG. 5.

FIG. 5 is a flowchart describing a method for building a first database according to an exemplary embodiment of the present disclosure.

The security service providing apparatus collects a plurality of pieces of wireless data from a plurality of wireless devices (hereinafter, referred to as ‘wireless devices for fingerprint collection’) that belong to the same wireless device type (S501).

For example, the security service providing apparatus collects a plurality of pieces of wireless data from a plurality of wireless devices that have a device species of ‘smartphone’. The collected pieces of wireless data may include, for example, at least one of OS information through analysis of a communication protocol, device driver information through analysis of a time difference between wireless service requests, oscillator's clock skew information, and RF information.

Meanwhile, the plurality of wireless devices belonging to the same wireless device type may be provided by an administrator.

The security service providing apparatus generates N wireless fingerprints based on N types of wireless data among the collected plurality of pieces of wireless data (S503).

For example, the plurality of pieces of wireless data collected from the wireless devices for fingerprint collection may include various kinds of information, such as OS information, device driver information, oscillator's clock skew information, and RF information.

The security service providing apparatus may generate a wireless fingerprint based on a plurality of pieces of information belonging to the same type among the various information included in the plurality of pieces of wireless data. For example, the security service providing apparatus may generate a first wireless fingerprint based on OS information, generate a second wireless fingerprint based on device driver information, generate a third wireless fingerprint based on oscillator's clock skew information, and generate a fourth wireless fingerprint based on RF information.

The security service providing apparatus selects at least one of the N wireless fingerprints based on a preset criterion (S505).

The security service providing apparatus, when selecting at least one of the generated N wireless fingerprints, may use an identification error rate.

For example, the security service providing apparatus may measure identification error rates of the N wireless fingerprints, and select a fingerprint an identification error rate of which is measured to be the lowest. For example, the security service providing apparatus may perform identification on the wireless device for fingerprint collection by using each of the N wireless fingerprints. Then, the security service providing apparatus may select a fingerprint having the highest recognition rate for the wireless device for fingerprint collection among N wireless fingerprints. For example, when the wireless device for fingerprint collection has a type of ‘smartphone’, a fourth wireless fingerprint generated based on RF information may have the lowest identification error rate among the first to fourth wireless fingerprints. In this case, the security service providing apparatus may select the fourth wireless fingerprint.

According to an exemplary embodiment of the present disclosure, the security service providing apparatus may select at least one of the N wireless fingerprints by further considering a preset threshold value. For example, the security service providing apparatus may select wireless fingerprints an identification error rate of which is measured to be smaller than the preset threshold value.

The security service providing apparatus registers the at least one wireless fingerprint selected in operation S505 as a wireless fingerprint corresponding to the concerned wireless device type (S507). That is, the security service providing apparatus registers a common wireless fingerprint for the wireless devices belonging to the same wireless device type.

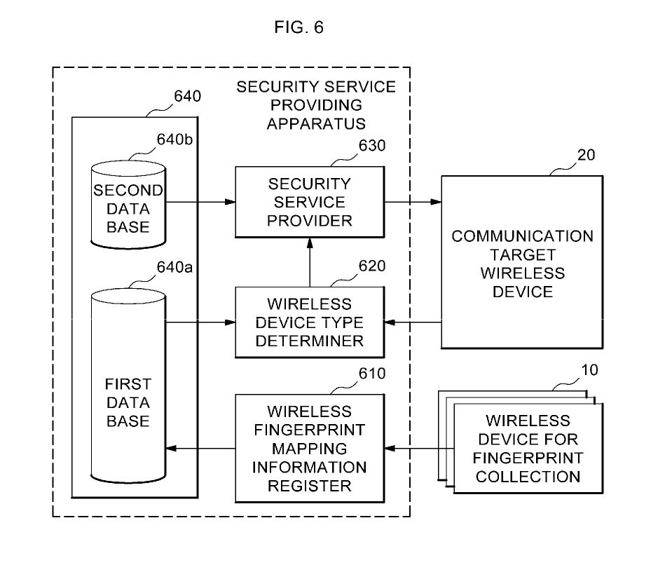

FIG. 6 is a block diagram describing an apparatus for providing a security service according to an exemplary embodiment of the present disclosure.

Referring to FIG. 6, the security service providing apparatus includes a wireless fingerprint mapping information register 610, a wireless device type determiner 620, a security service provider 630 and a storage 640. According to another exemplary embodiment of the present disclosure, at least one of the components described above may be omitted.

The wireless fingerprint mapping information register 610 may build a first database 640a based on wireless data collected from a plurality of wireless devices. The first database 640a may store mapping information in which respective wireless device types are mapped to wireless fingerprints corresponding thereto.

For example, the wireless fingerprint mapping information register 610 may collect a plurality of pieces of wireless data from a plurality of wireless devices 10 for fingerprint collection that belong to the same wireless device type. Then, the wireless fingerprint mapping information register 610 may generate N wireless fingerprints based on N types of wireless data among the collected plurality of pieces of wireless data. Then, the wireless fingerprint mapping information register 610 may select at least one of the generated N wireless fingerprints based on a preset criterion, and register the selected at least one wireless fingerprint as a wireless fingerprint corresponding to the concerned wireless device type.

According to an exemplary embodiment of the present disclosure, the wireless fingerprint mapping information register 610 may measure identification error rates of the generated N wireless fingerprints, select a wireless fingerprint an identification error rate of which is measured to be the lowest, and register the selected wireless fingerprint as a wireless fingerprint corresponding to the concerned wireless device type.

According to an exemplary embodiment of the present disclosure, the wireless fingerprint mapping information register 610 may measure identification error rates of the generated N wireless fingerprints, select wireless fingerprints an identification error rate of which is measured to be lower than a preset threshold value, and register the selected wireless fingerprint as a wireless fingerprint corresponding to the concerned wireless device type.

The wireless device type determiner 620 may obtain a wireless fingerprint of a communication target wireless device 20. The wireless device type determiner 620 may obtain the wireless fingerprint by analyzing at least one of wireless electromagnetic waves and a Media Access Control (MAC) frame of the communication target wireless device 20.

The wireless device type determiner 620 may determine a wireless device type corresponding to the obtained wireless fingerprint by referring to the first database 640a. That is, the wireless device type determiner 620 determines a wireless device type of the communication target wireless device 20.

The security service provider 630 determines a security policy corresponding to the wireless device type of the communication target wireless device 20 based on information about the type of the communication target wireless device 20 received from the wireless device type determiner 620 and based on a second database 640b. The second database 640b may store a security policy related to at least one of a notification, an access control and an authentication for each wireless device type.

In addition, the security service provider 630 applies the determined security policy to a service for the communication target wireless device 20.

The storage 640 stores the first database 640a and the second database 640b.

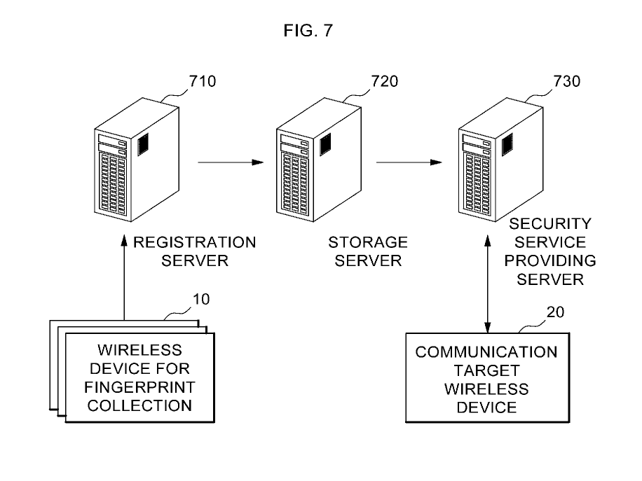

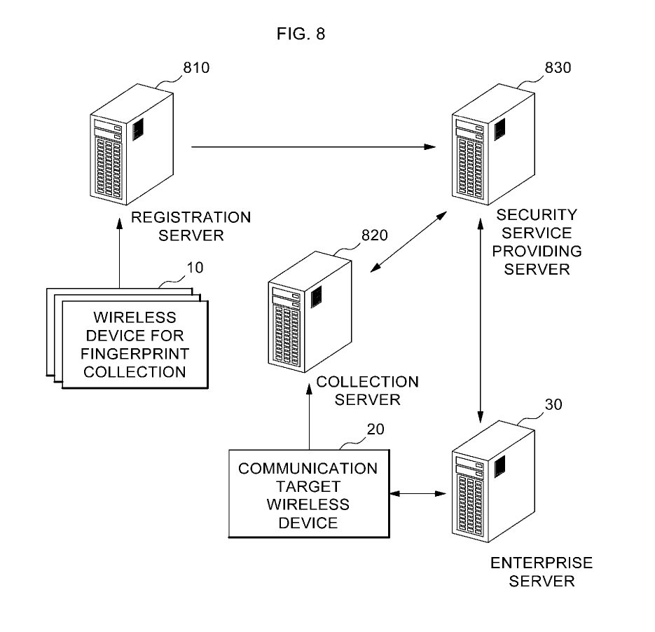

The wireless security service providing apparatus according to an exemplary embodiment of the present disclosure may be applied to a distributed environment. This will be described with reference to FIG. 7 and FIG. 8.

FIG. 7 is a diagram illustrating an example in which the security service providing apparatus according to an exemplary embodiment of the present disclosure is applied to a distributed environment.

Referring to FIG. 7, the security service providing apparatus may be disposed in a registration server 710, a storage server 720 and a security service providing server 730 in a distributed manner.

In the registration server 710, the wireless fingerprint mapping information register described with reference to FIG. 6 may be disposed. The registration server 710 may acquire a wireless fingerprint corresponding to a concerned wireless device type from wireless devices 10 for fingerprint collection, and store mapping information in which the concerned wireless device type is mapped to a wireless fingerprint corresponding thereto, in the storage server 720.

In the storage server 720, the storage described with reference to FIG. 6 may be disposed. The storage server 720 may store the first database including the mapping information and the second database including a security policy corresponding to a device type.

In the security service providing server 730, the device type determiner and the security service provider described with reference to FIG. 6 may be disposed. The security service providing server 730 may determine a wireless device type of a communication target wireless device 20 based on the wireless fingerprint of the communication target wireless device 20 and the first database stored in the storage server 720.

The security service providing server 730 may determine a security policy corresponding to the determined wireless device type by referring to the second database stored in the storage server 720, and provide the communication target wireless device 20 with a service according to the determined security policy.

Meanwhile, the providing of the security service may be achieved by interworking with a third server (for example, an enterprise server) that performs a communication with the communication target wireless device. This will be described with reference to FIG. 8.

FIG. 8 is a diagram illustrating another example in which the security service providing apparatus according to an exemplary embodiment of the present disclosure is applied to a distributed environment.

Referring to FIG. 8, the security service providing apparatus may be disposed in a registration server 810, a collection server 820 and a security service providing server 830 in a distributed manner.

In the registration server 810, the wireless fingerprint mapping information register described with reference to FIG. 6 may be disposed. The registration server 810 may acquire a wireless fingerprint corresponding to a concerned wireless device type from wireless devices 10 for fingerprint collection, and send the security service providing server 830 mapping information in which the concerned wireless device type is mapped to a wireless fingerprint.

In the collection server 820, the wireless device type determiner described with reference to FIG. 6 may be disposed. The collection server 820 may determine a wireless device type of a communication target wireless device 20 based on the mapping information received from the security service providing server 830 and the wireless fingerprint of the communication target wireless device 20. In addition, the collection server 820 may send the security service providing server 830 information about the wireless device type of the communication target wireless device 20 and identification information about the communication target wireless device 20 (for example, a MAC address).

In the security service providing server 830, the storage and the security service provider described with reference to FIG. 6 may be disposed. The security service providing server 830 may transmit the mapping information received from the registration server 810 to the collection server 820. In addition, the security service providing server 830 may receive the identification information about the communication target wireless device 20 (for example, a MAC address) and the information about the wireless device type of the communication target wireless device 20 from the collection server 820, and store the received information.

The security service providing server 830, upon receiving a request for determining wireless device type information about the communication target wireless device 20 from an enterprise server 30, may provide the enterprise server 30 with the information about the type of the communication target wireless device 20 based on the information received from the collection server 820.

Accordingly, the enterprise server 30 performs an access control and an authentication on the communication target wireless device 20 based on a security policy that is provided in the enterprise server 30.

The above described exemplary embodiments described in the specification may be implemented in various methods. For example, the exemplary embodiments may be implemented using hardware, software or a combination thereof, for example, software executed on one or more processors using various operating systems or platforms. In addition, the software may be written using any one of appropriate programming languages, and may be compiled to a machine code or an intermediate code executable by a framework or a virtual machine.

When executed on one or more processors, the exemplary embodiments may be implemented in a processor readable medium that records one or more programs to perform the method for implementing the various exemplary embodiments described in the specification (for example, a memory, a floppy disk, a hard disk, a compact disk, an optical disk or a magnetic tape).

It will be apparent to those skilled in the art that various modifications can be made to the above-described exemplary embodiments of the present disclosure without departing from the spirit or scope of the invention. Thus, it is intended that the present disclosure covers all such modifications provided they come within the scope of the appended claims and their equivalents.

What is claimed is:

1. A method for providing a security service for a wireless device, the method comprising:
obtaining a wireless fingerprint of a wireless device;
determining a wireless device type corresponding to the obtained wireless fingerprint by referring to a first database;
determining a security policy corresponding to the determined wireless device type by referring to a second database; and
applying the determined security policy to a service for the wireless device.

2. The method of claim 1, wherein the wireless fingerprint includes at least one of an Operating System (OS) fingerprint, a device driver fingerprint, a clock fingerprint, a Radio Frequency (RF) fingerprint, and an Organizationally Unique Identifier (OUI) fingerprint.

3. The method of claim 1, wherein the obtaining of the wireless fingerprint comprises obtaining the wireless fingerprint by analyzing at least one of wireless electromagnetic waves and a Media Access Control (MAC) frame of the wireless device.

4. The method of claim 1, wherein the wireless device type is divided based on at least one of an operating system, a manufacturer and a device species.

5. The method of claim 1, wherein the second database stores a security policy related to at least one of a notification, an access control, and an authentication for each wireless device type.

6. The method of claim 1, wherein the first database stores mapping information in which respective wireless device types are mapped to wireless fingerprints corresponding thereto.

7. The method of claim 1, further comprising building the first database based on a plurality of pieces of wireless data collected from a plurality of wireless devices.

8. The method of claim 7, wherein the building of the first database comprises:
collecting a plurality of pieces of wireless data from a plurality of wireless devices belonging to a same wireless device type;
generating N wireless fingerprints based on N types of wireless data among the collected plurality of pieces of wireless data;
selecting at least one of the generated N wireless fingerprints according to a preset criterion; and
registering the selected wireless fingerprint as a fingerprint corresponding to a concerned wireless device type.

9. The method of claim 8, wherein the selecting of the at least one of the N wireless fingerprints comprises:
measuring identification error rates of the generated N wireless fingerprints; and
selecting a wireless fingerprint an identification error rate of which is measured to be the lowest.

10. The method of claim 8, wherein the selecting of the at least one of the N wireless fingerprints comprises:
measuring identification error rates of the generated N wireless fingerprints; and
selecting wireless fingerprints an identification error rate of which is measured to be smaller than a preset threshold value.

11. An apparatus for providing a security service for a wireless device, the apparatus comprising:
a wireless device type determiner configured to obtain a wireless fingerprint of a wireless device, and determine a wireless device type corresponding to the obtained wireless fingerprint by referring to a first database;
a security service provider configured to determine a security policy corresponding to the determined wireless device type by referring to a second database, and apply the determined security policy to a service for the wireless device.

12. The apparatus of claim 11, wherein the wireless fingerprint includes at least one of an Operating System (OS) fingerprint, a device driver fingerprint, a clock fingerprint, a Radio Frequency (RF) fingerprint and an Organizationally Unique Identifier (OUI) fingerprint.

13. The apparatus of claim 11, wherein the wireless device type determiner obtains the wireless fingerprint by analyzing at least one of wireless electromagnetic waves and a Media Access Control (MAC) frame of the wireless device.

14. The apparatus of claim 11, wherein the wireless device type is divided based on at least one of an operating system, a manufacturer and a device species.

15. The apparatus of claim 11, wherein the second database stores a security policy related to at least one of a notification, an access control and an authentication for each wireless device type.

16. The apparatus of claim 11, wherein the first database stores mapping information in which respective wireless device types are mapped to wireless fingerprints corresponding thereto.

17. The apparatus of claim 11, further comprising a wireless fingerprint mapping information register configured to build the first database based on wireless data collected from a plurality of wireless devices.

18. The apparatus of claim 17, wherein the wireless fingerprint mapping information register is configured to collect a plurality of pieces of wireless data from a plurality of wireless devices belonging to a same wireless device type, generate N wireless fingerprints based on N types of wireless data among the collected plurality of pieces of wireless data, select at least one of the generated N wireless fingerprints according to a preset criterion, and register the selected wireless fingerprint as a fingerprint corresponding to a concerned wireless device type.

19. The apparatus of claim 18, wherein the wireless fingerprint mapping information register is configured to measure identification error rates of the generated N wireless fingerprints, select a wireless fingerprint an identification error rate of which is measured to be the lowest, and register the selected wireless fingerprint as a fingerprint corresponding to the concerned wireless device type.

20. The apparatus of claim 18, wherein the wireless fingerprint mapping information register is configured to measure identification error rates of the generated N wireless fingerprints, select wireless fingerprints an identification error rate of which is measured to be smaller than a preset threshold value, and register the selected wireless fingerprint as a fingerprint corresponding to the concerned wireless device type.
